(19) United States
(12) Patent Application Publication
(10) Pub. No.: US 2026/0185936 A1
(43) Pub. Date: Jul. 2, 2026

(54) Slow-light Prism Enhanced Spectroscopy (SLOPES)

(71) Applicant: The Texas A&M University System, College Station, TX (US)

(72) Inventors: Richard B. MILES, Bryan, TX (US); Amirhossein ABBASSZADEHRAD, College Station, TX (US); Jason Matthew MEYERS, Bryan, TX (US); Arthur DOGARIU, College Station, TX (US)

(21) Appl. No.: 18/904,521

(22) Filed: Oct. 2, 2024

Related U.S. Application Data
(60) Provisional application No. 63/587,515, filed on Oct. 3, 2023.

(51) Int. Cl. G01N 21/39

(52) U.S. Cl. CPC G01N 21/39; G01N 2201/0634

(57) ABSTRACT

Slow-light prism enhanced spectroscopy (SLOPES) is described. In one embodiment, a method for characterizing spectral properties of a sample includes illuminating a material sample by a tunable source of light. In response to illuminating the material sample, scattered light is produced, where the scattered light embodies spectral properties of the sample. Method also includes, passing the scattered light through a vapor prism cell. The vapor prism cell includes prismatic surfaces in a path of the scattered light. The vapor prism cell contains gas that is configured to selectively slow down propagation velocities at different spectral features of the scattered light and to disperse different spectral features of the scattered light at separate angles. The method also includes acquiring signals corresponding to time-gated spectral properties of the scattered light after propagating through the vapor prism cell. The acquired signals are discriminated in time based on acquired signals' time-gated properties and in space based on acquired signals' dispersion angle and subsequent location on an acquisition plane. Spectral features of the scattered light are determined based on the acquired signals.

### CROSS-REFERENCE TO RELATED APPLICATION

This application claims the benefit of U.S. Patent Application No. 63/587,515, filed Oct. 3, 2023, the disclosure of which is hereby incorporated by reference in its entirety.

### STATEMENT OF GOVERNMENT LICENSE RIGHTS

This invention was made with government support under the Office of Naval Research, Award #N00014-23-1-2458, technical monitor Dr. Eric Marineau; and Award #N00014-23-1-2466, technical monitor Dr. Joong Kim.

### BACKGROUND

Current methods to achieve high-resolution Raman spectroscopy require either exceptionally narrow slits at the entrance of long-path, dual or triple spectrometers, or interferometers that require well-collimated light. Any of these conventional approaches severely limit the light collection capability either with a small spatial aperture or by a small collection solid angle. Accordingly, systems and methods for high-resolution spectroscopy are still needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The inventive technology is directed to methods and systems for spectroscopy that are achieved by combining refraction and propagation delays of light pulses that pass through a prism cell filled with atomic vapor. The atomic vapor medium is characterized by strong refractive index gradients near the atomic resonant absorption features, and these features enable separation of light pulses in space (i.e., by refraction) and in time (i.e., by the propagation delays) of different spectral features of a light pulse that propagates through the vapor cell. In particular, the time delays are affected by the gradient of the refractive index that leads to slowing of the light pulses, while simultaneously the magnitude of the refractive index and the prismatic windows or internal prisms elements of the atomic vapor cell spatially separate light pulses due to dispersion. This approach replaces the standard spectrometer with an atomic vapor prism cell placed in front of a time gated detector.

Slow light alone is not sufficient to achieve the desired high resolution due to refractive index side bands, and light dispersion alone does not provide sufficiently strong suppression of background for weak spectral features. The amalgamation of the two effects into a single apparatus is what enables improved detection of the material of the sample. High resolution is achieved with a narrow linewidth, pulsed frequency tunable laser rather than a diffraction grating. The inventive dual resolving method greatly increases the light collection over the conventional methods, strongly suppresses background and out-of-band light, and preserves 2D imaging capability. In operation, the laser is tuned such that the spectral line of interest falls near the resonance of the atomic vapor. Applications for rotational Raman spectroscopy are of particular interest, since specific Raman lines can be selected while other Raman lines as well as background Rayleigh and other scattering are strongly rejected. Therefore, slow-light prism enhanced spectroscopy (SLOPES) has potential to significantly increase collection efficiency and spectral resolution compared to standard grating spectroscopy and interferometry. The inventive technology enables high resolution differential detection of closely separated spectral features, and it provides strong out-of-band suppression.

In the context of this specification, the expression “scattering” may refer to: Raman scattering, Rayleigh scattering, Thomson scattering, Brillouin scattering, Mie scattering, etc. In the context of this specification, the word “light” encompasses both visible and invisible wavelengths of electromagnetic radiation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of the claimed subject matter will become more readily appreciated as the same become better understood by reference to the following detailed description, when taken in conjunction with the accompanying drawings, wherein:

FIG. 1 is a graph of slow light effect in accordance with embodiments of the present technology;

FIG. 2 is a schematic view of a spectrometry system in accordance with embodiments of the present technology;

FIG. 3 is a partially schematic view of an atomic vapor prism cell in accordance with embodiments of the present technology;

FIG. 4 is a partially schematic view of an atomic vapor cell containing multiple prisms in accordance with embodiments of the present technology;

FIGS. 5A, 5B, and 5C illustrate Rayleigh scattering by an atomic vapor prism cell in accordance with embodiments of the present technology;

FIG. 6 is a graph illustrating undelayed and delayed signals in accordance with embodiments of the present technology; and

FIG. 7 shows experimental results of spectrometric measurements in accordance with embodiments of the present technology.

### DETAILED DESCRIPTION

While illustrative embodiments have been illustrated and described, it will be appreciated that various changes can be made therein without departing from the spirit and scope of the invention.

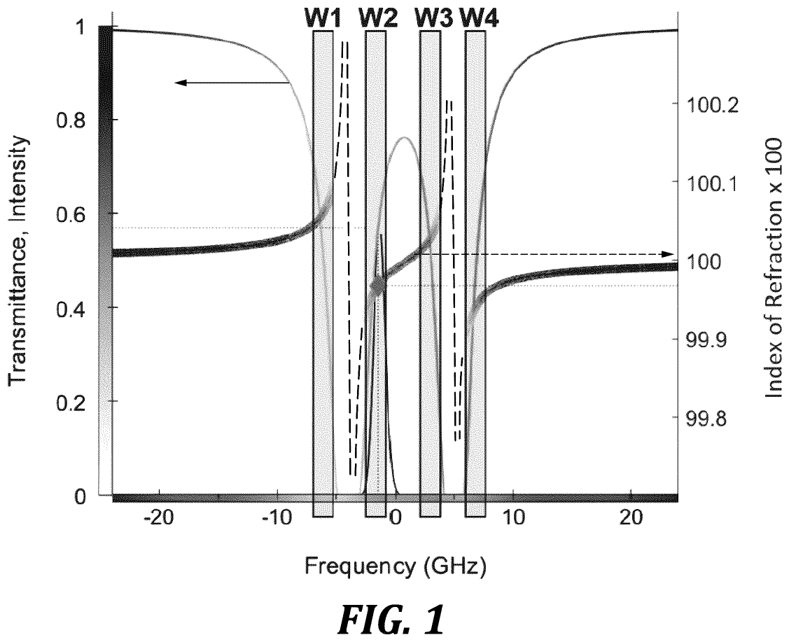

FIG. 1 is a graph of slow light effect in accordance with embodiments of the present technology. The horizontal axis shows frequency shift of light in GHz. The left vertical axis shows transmittance of the light through the sample, and the right vertical axis shows the index of refraction that is scaled by a factor of 100. The transmittance is shown as the colored curve against the left-side vertical axis. The color of this curve changes from red to blue depending on the frequency shown with the color bar on the horizontal axis. The index of refraction is shown by the brown curve corresponding to the right-side vertical axis. The color of this curve changes from dark brown to white depending on the transmittance shown with the color bar on the left axis. The horizontal arrows are aids in reading the graph. The four vertical spectral windows that are labeled W1 to W4 represent four spectral bands with sufficient transmittance and delay through the vapor prism cell to enable background suppression.

Cesium is characterized by two resonance lines at 852.1 nm leading to four spectral windows W1-W4 capable of slowing down the light on each side of the two resonance lines as shown in FIG. 1. That is, each of the two resonance lines of cesium is sandwiched between the two vertical spectral windows W1/W2 and W3/W4. Since these spectral windows labeled W1, W2, W3, and W4 are not too close to the absorption lines, the transmittance (left vertical axis) within them is enough to pass the light signal. Additionally, since the spectral windows W1, W2, W3, and W4 are not too far from the absorption lines, the slope of the index of refraction (i.e., slope of the brown curve) within them is enough to delay the signal beyond the time the gate opens. Thus, the spectral windows labeled W1, W2, W3, and W4 operate as band-pass filters for the incoming light. Any frequency of the light that is outside these spectral windows will be rejected due to either too much absorption or insufficient delay.

Although the slope of the index of refraction in all these spectral windows W1-W4 is similar, the magnitude of the index of refraction is not. While the slow light effect (i.e., slowing down of the propagation velocities) is determined by the slope of the index of refraction (i.e., slope of the brown line in FIG. 1 for a particular wavelength), the dispersion effect is determined by the magnitude of the index of refraction. Therefore, these four spectral windows generate approximately the same delay, but the prism cell introduces different deflection (dispersion) angles to the light passing through it. A prism vapor cell utilizes the difference in dispersion caused by these angled windows to separate light passed and delayed by each spectral window W1-W4 at their corresponding frequencies. By selecting the output of only one spectral window and discarding the others through picking the signal at a certain location on the image plane corresponding to the deflection angle introduced associate with that spectral window, the resolution is significantly improved. The detection bandwidth becomes narrower, because it includes only one spectral window and excludes others as opposed to including all spectral windows. Therefore, the resolution of the spectrometer is greatly enhanced.

Stated differently, the resolution or accuracy of a spectroscopic measurement is not necessarily improved by simply increasing the number of measurable output signals. Instead, with the embodiments of the inventive technology we can improve the resolution by discarding all but one of output signals (2), (3), and (4). Furthermore, an ultra-narrow band-pass filter cam be created by discarding output signal (1). Such band-pass filter is effectively created by the combination of the vapor cell and the gated camera, which blocks the output signal (1) that is not supposed to pass through the filter. Thus, the inventive technology relies on excluding as many outputs as possible to increase the resolution.

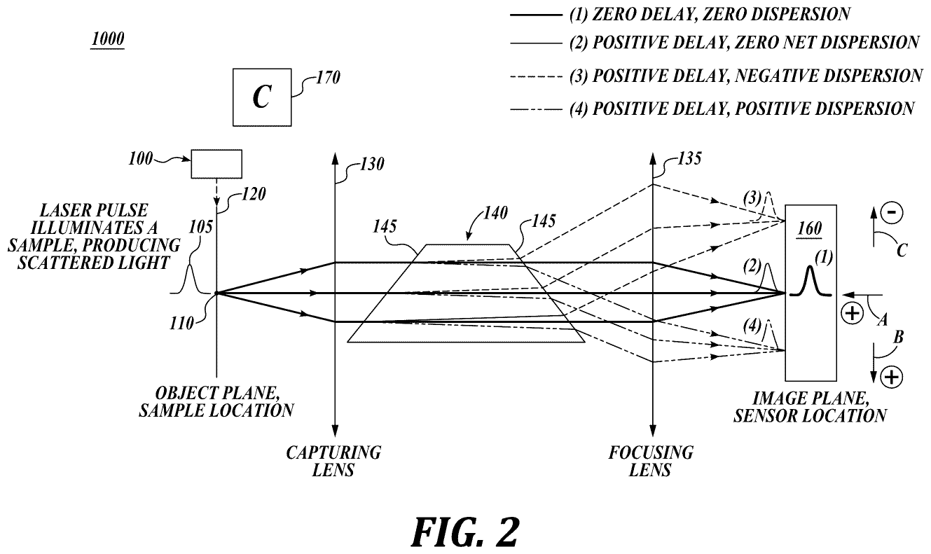

FIG. 2 is a schematic view of a spectrometry system 1000 in accordance with embodiments of the present technology. In operation, a source of light 100 produces light pulses 120 at a tunable frequency. In some embodiments, the source of light 100 includes a laser, light from a diffraction grating, or light from an Optical Parametric Oscillator (OPO) that produce a tuned output at near 852 nm. Many other wavelengths are also possible corresponding to various atomic vapors and their resonant transitions. In one embodiment, the second harmonic of the Nd: YAG laser output at 532 nm (for example, Ekspla NL310 laser) is used to pump a dye laser system (Sirah Cobra Stretch) which incorporates a dual 1800 g/mm grating configuration to provide frequency tunability. An LDS 867 dye in ethanol solvent in the oscillator and amplifier may be used to produce near 852 nm tunable output. In other embodiments, an Optical Parametric Oscillator (OPO) or a Titanium Sapphire laser can also produce tunable laser pulses at target wavelengths.

The output pulses of the laser beam 120 are directed to a test sample 110, thus producing a scattered light 105 at the illustrated object plane sample location. The scattered light embodies spectral properties of the test sample 110. The scattered light is directed toward an optical cell (a vapor prism cell) 140 through a capturing lenses 130. In some embodiments, a φ1 in., 125 mm focal length lens is positioned to collect light at 90° with respect to the probe beam path. This lens collects the scattered light from the sample 110 at the object plane, and then collimates it to pass through a φ1 in. sloped walled prism (optical cell) 140.

In some embodiments, the sloped walled prism 140 is a heated cesium cell with an average length of 75 mm. In some embodiments, the sample 110 is 1 atmosphere of CO₂. In different embodiments, the vapor in the vapor prism cell 140 can include cesium, rubidium, mercury, sodium, potassium, and other atomic vapors that have a steep variation of index of refraction around a resonance line. As explained with respect to FIG. 1 above, the light entering the vapor prism cell 140 segregates based on two effects: (a) slow light effect (i.e., slowing down of the propagation velocities) that is determined by the slope of the index of refraction, and (b) the dispersion effect that is determined by the magnitude of the index of refraction and the geometry of the prism cell. For example, the double hyperfine split resonance lines of cesium that are separated by 9 GHz at 852.1 nm (shown in FIG. 1) may be used to slow down the light and cause the dispersion of the light based on differences in the slope and magnitude of the index of refraction.

The light leaving the vapor prism cell 140 is captured by a focusing lens 135 (e.g., a Ø2 in., 100 mm focal length ZEISS Milvus 2/100M) and is directed to an image capture camera 160 that is, for example, a combination of a gated intensifier (e.g., LaVision IRO-S25) and a cooled CCD camera (e.g., Hamamatsu ORCA-ER C4742-95). The gated intensifier acts as a fast shutter, only detecting light during the “on” time, which can be controlled to sub nanosecond accuracy. In some embodiments, the green output of the intensifier phosphor is captured by a cooled CCD camera. In some embodiments, the image capture camera 160 captures images of the CO2 scattering based on time gating, thus being capable of capturing either a non-delayed output (1)—zero time delay, zero light dispersion far from the atomic resonance light; or the delayed near resonance outputs, that is, the outputs (2)—positive time delay, zero net dispersion; (3)—positive time delay, positive dispersion; and (4)—positive time delay, negative dispersion. Therefore, output (signal) (1) is discriminated from outputs (signals) (2)-(4) in time based on acquired signals' time-gated properties and outputs (signals) (2)-(4) are discriminated in space based on acquired signals' location on the acquisition plane of the image capture camera 160.

Operation of the spectrometry system 1000 can be controlled by a controller 170. A person of ordinary skill would know that the above-listed components of the spectrometry system 1000 are provided as illustrative examples only, and that different examples of off the shelf or custom-made components are also available in other embodiments. For example, various vapor prism cell configurations may be applicable including a relatively simple cell with sloping windows to a cell that contains internal prisms. Many components required for the present spectroscopic method, including a tunable pulsed laser and a gated image capture camera or detector, are commercially available.

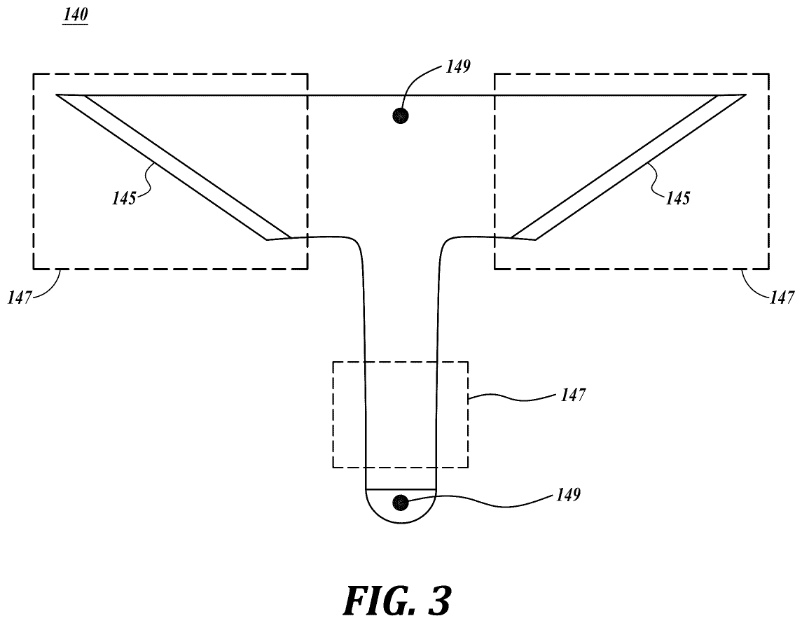

FIG. 3 is a partially schematic view of an atomic vapor prism cell 140 in accordance with embodiments of the present technology. In some embodiments, atomic vapor prism cell is a rubidium prism cell having sloped windows (also referred to as prismatic surfaces) 145 and operating near the rubidium resonances at 780 nm or 794.8 nm. In operation, the prism cell 140 may be heated by electrical heaters 147 (or other source of heat) to a target temperature that is measured by temperature sensors (e.g., a thermocouple) 149. Controlling the temperature of the prism cell 140 can improve the measurements, because a higher side arm temperature increases the vapor pressure and the number density of atoms in the vapor prism cell, which in turn increases the optical thickness of the cell. In turn, increasing the optical thickness causes the delay spectral windows to move away from their corresponding resonance lines. In some embodiments, the sloped windows are Brewster windows to minimize reflection and maximize transmission through the sloped windows. In some embodiments, two more windows and two tubes are placed at each side of the prism cell 140 to create hot chambers around sloped windows, and to prevent condensation of atoms on cell windows. In some embodiments, these two extra windows are coated by an anti-reflective coating to minimize back reflection and maximize transmission through the extra windows.

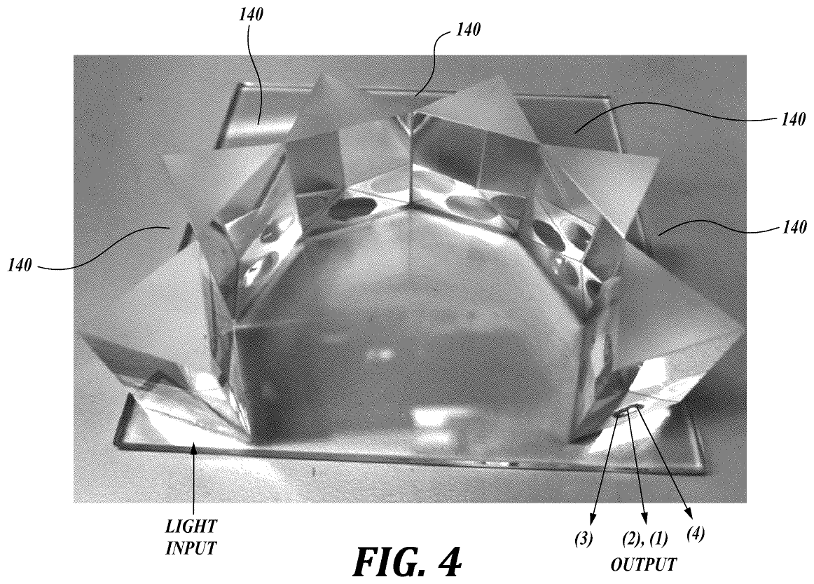

FIG. 4 is a partially schematic view of an atomic vapor cell containing one or more prisms of a transparent solid material such as sapphire or quartz in accordance with embodiments of the present technology. The atomic vapor surrounds the transparent solid material prisms, and the multiple interfaces multiply the dispersion. Generally, a cell containing multiple prisms 140 increases the dispersion effect and also the delay effect. Therefore, spectroscopy based on multiple prisms 140 may result in improved resolution of the measurements. Multiple atomic vapor prisms may also be configured in sequences to enhance dispersion.

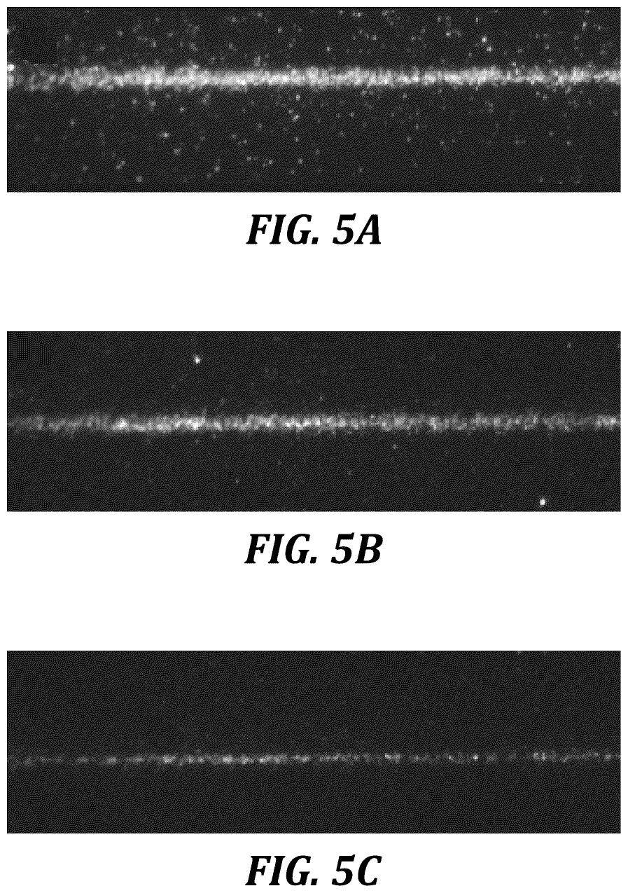

FIGS. 5A, 5B, and 5C illustrate Rayleigh scattering by an atomic vapor prism cell in accordance with embodiments of the present technology with a cesium vapor prism cell. In particular, the three illustrated images of the focused beam are formed by the delayed Rayleigh scattering from a CO₂ sample obtained at different frequencies. Images in FIGS. 5A, 5B, and 5C respectively correspond to −7.5, 0, and +7.5 GHz offset from the 0 GHz reference frequency illustrated in FIG. 1. The collected light undergoes delay and dispersion as it passes through the heated cesium prism cell (vapor prism cell) 140 before being captured by the gated intensifier and the camera. Focusing attention to the rightmost edge of each of the FIGS. 5A, 5B, and 5C, the exit point of the beam at the three different frequencies occurs at different locations of the camera due to varying indices of refraction at each frequency, respectively corresponding to outputs (4), (2), and (3) of FIG. 2. This is because the rays of each frequency experience different amounts of deflection as they pass through the prism due to the different indices of refraction. On the other hand, time delays of the rays of each frequency are similar based on similar slope of the index of refraction for each of the three rays. The side arm temperature in the illustrated case is 119° C.

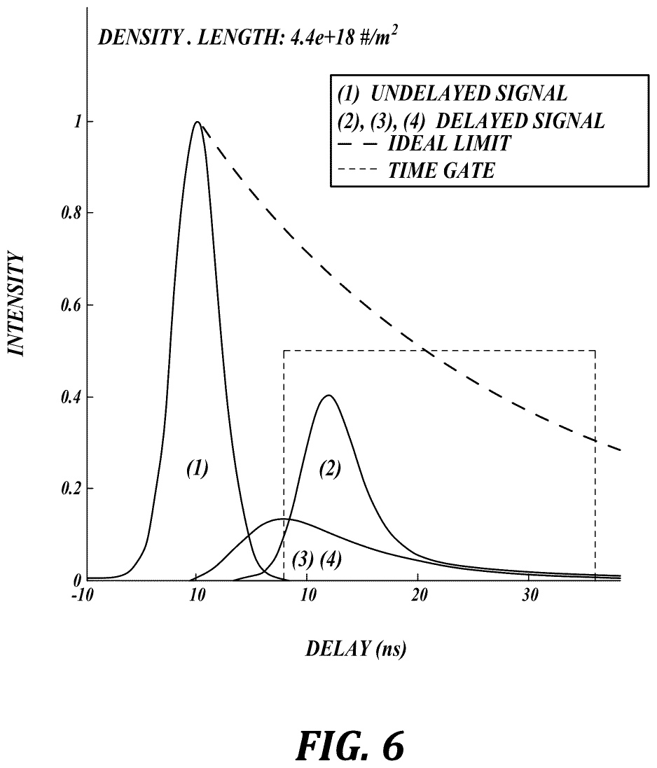

FIG. 6 is a graph illustrating undelayed and delayed signals in accordance with embodiments of the present technology. The horizontal axis represents delays of light pulses in ns. These delays are caused by the light pulses propagating through the vapor prism cell 140. Therefore, the non-delayed signal (1) is centered about the value 0 ns, whereas the delayed signals (2), (3), and (4) are centered about their respective positive time delay values. The vertical axis represents intensity of light, showing that the non-delayed signal (1) has the highest peak intensity and the smallest variance. Referring back to FIG. 1), there are four spectral windows W1-W4, but as, for example, the side-arm temperature of the prism cell 140 is increased, the two middle windows (W2 and W3) merge resulting in three spectral peaks corresponding to output signals (2), (3), and (4).

The time gate rectangle represents a time window during which the output signals are acquired. The illustrated time gate is configured to capture output signals (2), (3), and (4), to the exclusion of output signal 1.

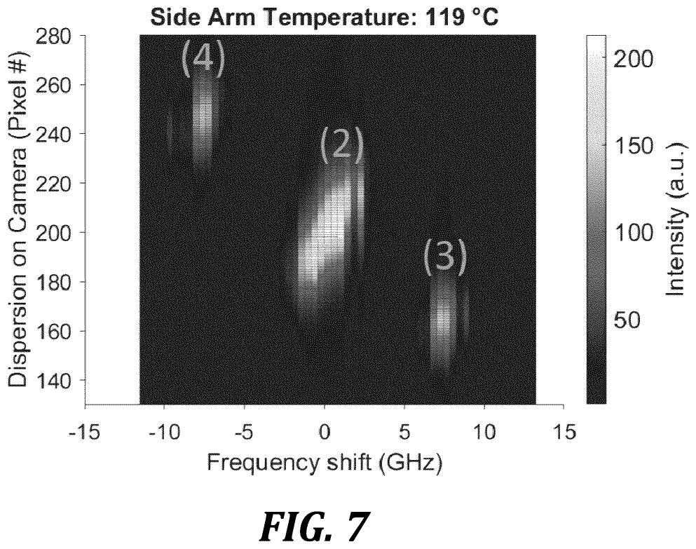

FIG. 7 shows experimental results of spectrometric measurements in accordance with embodiments of the present technology. The horizontal axis shows frequency shift in GHz. The vertical axis shows dispersion on camera. Each number on the vertical axis corresponds to the number of each row of pixels on the camera chip. The intensity of the signal is indicated by the color legend on the right-hand side of the graph. The results were obtained using the time gate shown in FIG. 6 to capture the output signals (2), (3), and (4) on an acquisition plane (e.g., plane of CCD pixels) of the image capture camera 160.

The side arms of the vapor prism cell 140 was kept at 119° C. A higher side arm temperature increases the vapor pressure and the number density of the gas atoms inside the cell 140, which in turn increases the optical thickness of the cell. Increasing the optical thickness causes these delay spectral windows to move away from their corresponding resonance lines. The two spectral windows between the two hyperfine cesium lines move towards each other and form one stronger spectral peak of the output signal. In the context of this specification, the term “spectral peak” refers to a point where the maximum value of the intensity of a given physical property occurs, but the term also refers to the entire area of the spectral peak maximum within, for example, +/5%, +/10%, or similar of the maximum point. Furthermore, the inventive technology can also measures various parameters of the spectral peaks, including their width, position on the frequency axis, shape, and more.

The illustrated results are based on the synergistic effects of dispersion and propagation delay in atomic vapor cells, thereby enhancing the resolution and selectivity in spectral analysis. Furthermore, the inventive technology, in contrast to the conventional technologies, does not suffer from the limitations of narrow slits or the necessity of well-collimated light, thereby improving its light collection efficiency.

The presently disclosed and/or claimed inventive concept(s) is capable of other embodiments or of being practiced or carried out in various ways. Also, it is to be understood that the phraseology and terminology employed herein is for the purpose of description and should not be regarded as limiting. Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

In the context of this disclosure, the terms “about,” “approximately,” “generally” and similar mean+/−5% of the stated value.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

1. A method for characterizing spectral properties of a sample, the method comprising:
illuminating a material sample by a tunable source of light;
in response to illuminating the material sample by the source of light, producing scattered light, wherein the scattered light embodies spectral properties of the sample;
passing the scattered light through a vapor prism cell, wherein the vapor prism cell comprises prismatic surfaces in a path of the scattered light, and wherein the vapor prism cell contains gas that is configured to selectively slow down propagation velocities at different spectral features of the scattered light and to disperse the different spectral features of the scattered light at separate frequency-dependent angles;
acquiring signals corresponding to time-gated spectral properties of the scattered light after propagating through the vapor prism cell, wherein acquired signals are discriminated in time based on the acquired signals' time-gated properties and in space based on the acquired signals' frequency-dependent angle that determines location on an acquisition plane; and
determining the spectral features of the scattered light based on the acquired signals.

2. The method of claim 1, wherein the tunable source of light is configured to generate wavelengths of light that correspond to at least one high transmittance wavelength and a time delayed spectral window of the vapor prism cell.

3. The method of claim 1, wherein the vapor prism cell is configured to selectively slow down propagation velocities at different spectral features of the scattered light by controlling vapor pressure within the vapor prism cell.

4. The method of claim 1, wherein a time gate is configured to selectively include signals of interest within a time span of signal acquisition.

5. The method of claim 4, wherein spectral peaks of the acquired signals correspond to spectral properties of time delayed signals.

6. The method of claim 4, wherein spectral peaks of the acquired signals correspond to spectral properties of undelayed signals.

7. The method of claim 4, wherein spectral peaks of the acquired signals are selected from:
(a) spectral peaks with no time delays and no net dispersion;
(b) spectral peaks with positive time delays and no net dispersion;
(c) spectral peaks with the positive time delays and positive net dispersion; and
(d) spectral peaks with the positive time delays and negative net dispersion.

8. The method of claim 5, wherein the time delayed signals comprise an image of the spectral peaks.

9. The method of claim 1, wherein an optical thickness of the vapor prism cell is determined by a length of the cell and an atomic vapor pressure of the gas.

10. The method of claim 9, wherein the atomic vapor pressure is determined by a temperature of a side arm and the vapor prism cell.

11. The method of claim 9, wherein the gas is selected from a group consisting of cesium, rubidium, mercury, sodium, potassium, and other atomic vapor that has a steep variation of index of refraction around a resonance line.

12. The method of claim 1, wherein the vapor prism cell comprises multiple prism cells in series.

13. The method of claim 1, wherein the vapor prism cell contains internal prisms of a transparent solid material surrounded by an atomic vapor.

14. A system for characterizing spectral properties of a sample, the system comprising:
a tunable source of light configured for illuminating a material sample, wherein, in response to illuminating the material sample by the source of light, scattered light that embodies spectral properties of the sample is produced;
a vapor prism cell configured for passing the scattered light through, wherein the vapor prism cell comprises prismatic surfaces in a path of the scattered light, and wherein the vapor prism cell contains gas that is configured to selectively slow down propagation velocities at different spectral features of the scattered light and to disperse the different spectral features of the scattered light at separate frequency-dependent angles; and
an image capture camera configured for acquiring signals corresponding to time-gated spectral properties of the scattered light after propagating through the vapor prism cell, wherein acquired signals are discriminated in time based on the acquired signals' time-gated properties and in space based on the acquired signals' frequency-dependent angle that determines location on an acquisition plane.

15. The system of claim 14, wherein the tunable source of light is configured to generate wavelengths of light that correspond to at least one high transmittance wavelength spectral window of the vapor prism cell.

16. The system of claim 14, wherein the vapor prism cell is configured to selectively slow down propagation velocities at different spectral features of the scattered light by controlling vapor pressure within the vapor prism cell.

17. The system of claim 14, wherein operation of the image capture camera is controlled by a time gate that is configured to selectively include signals of interest within a time span of signal acquisition.

18. The system of claim 17, wherein spectral peaks of the acquired signals correspond to spectral properties of time delayed signals.

19. The system of claim 17, wherein spectral peaks of the acquired signals correspond to spectral properties of undelayed signals.

20. The system of claim 14, wherein an optical thickness of the vapor prism cell is determined by a length of the cell and an atomic vapor pressure of the gas.

21. The system of claim 20, wherein the atomic vapor pressure is determined by a temperature of a side arm and the vapor prism cell.

22. The system of claim 14 wherein the vapor prism cell contains internal prisms of a transparent solid material surrounded by an atomic vapor.
